(19) United States
(12) Patent Application Publication
(10) Pub. No.: US 2007/0294851 A1
(43) Pub. Date: Dec. 27, 2007

(54) Windscreen Wiper System for Vehicles and a Fixing Element for Such a System

(75) Inventors: Bruno Egner-Walter, Heilbronn (DE); Michael Schauble, Bietigheim-Bissingen (DE)

Correspondence Address: OSHA LIANG L.L.P., 1221 MCKINNEY STREET, SUITE 2800, HOUSTON, TX, 77010, US

(73) Assignee: Valeo Systèmes d'Essuyage, La Verriere (FR)

(21) Appl. No.: 10/590,425

(22) PCT Filed: Feb. 21, 2005
(86) PCT No.: PCT/EP05/01771

§ 371 Date: Jun. 18, 2007

(30) Foreign Application Priority Data
Feb. 23, 2004 (DE) 10 2004 009 040.8

(51) Int. Cl. B60S 1/04; B60J 1/20

(52) U.S. Cl. 15/250.21

(57) ABSTRACT

With a windscreen wiper system for motor vehicles with at least three connections or fixings at intervals from one another for screw-free installation of the windscreen wiper system on vehicle bodywork, the fixings consist respectively of a fixing element which can be pushed into an attachment or fixing hole where it can be anchored by engagement. At least one fixing element has a grommet in elastic material which can be inserted into the attachment or fixing hole, designed with at least one projection acting as a catch. In order to reduce the installation force, at least one cavity is arranged radially inwards in the area of and opposite the projection with reference to a grommet axis.

The invention refers to a windscreen wiper system for vehicles, particularly road vehicles according to the generic term in patent claim 1 and to a fixing element for such systems according to the generic term in patent claim 17.

So-called Plug & Wipe—wiping systems are known, which are installed in the respective vehicle by means of fixings or connections, which consist of peg-type fixing elements on the windscreen wiper system or on a carrier at this position and attachment or fixing holes on the vehicle or bodywork side in which the fixing elements are anchored by pushing in and engagement.

The peg-type fixing elements consists in this case among other aspects of an elastic bush or grommet, which forms an axial contact surface with a flange-like section of bush projecting over the circumference of the bush at one bush end and which is equipped with a catch projecting over the circumference of the bush at the other bush end. It is a disadvantage here that sufficiently secure anchoring of the windscreen wiper system in the vehicle, which (the anchoring) prevents accidental detachment and removal when the windscreen wiper system is operating, also means that on installation, a high installation force is necessary owing to the necessary deformation of the bush in this case.

The task of the invention is to remove this disadvantage and achieve an anchoring with a high load bearing capacity with reduced installation force. In order to solve this task, a windscreen wiper system corresponding to patent claim 1 is designed. A fixing element for use with a windscreen wiper system is designed according to patent claim 17.

With the design according to the invention, a isolation of the high load bearing capacity anchoring and the installation force is advantageously achieved and to be precise, by the fact that owing to the at least one cutout for which provision is made in addition to the bush or grommet opening, a space is created in which the material of the grommet when the latter is pushed into the respective attachment or fixing hole can move aside until engagement, so that installation with reduced expenditure of force is possible as a result and indeed also when using a material for the grommet that allows the high load bearing capacity anchoring sought after through increased stiffness, so that separation of the respective connection is only possible with the use of forces which are considerably greater than the forces with which the connections are loaded during normal operation of the windscreen wiper system.

Further designs of the invention are the subject of the sub-claims. The invention will be described in more detail below based on the figures in examples of realisation. They show:

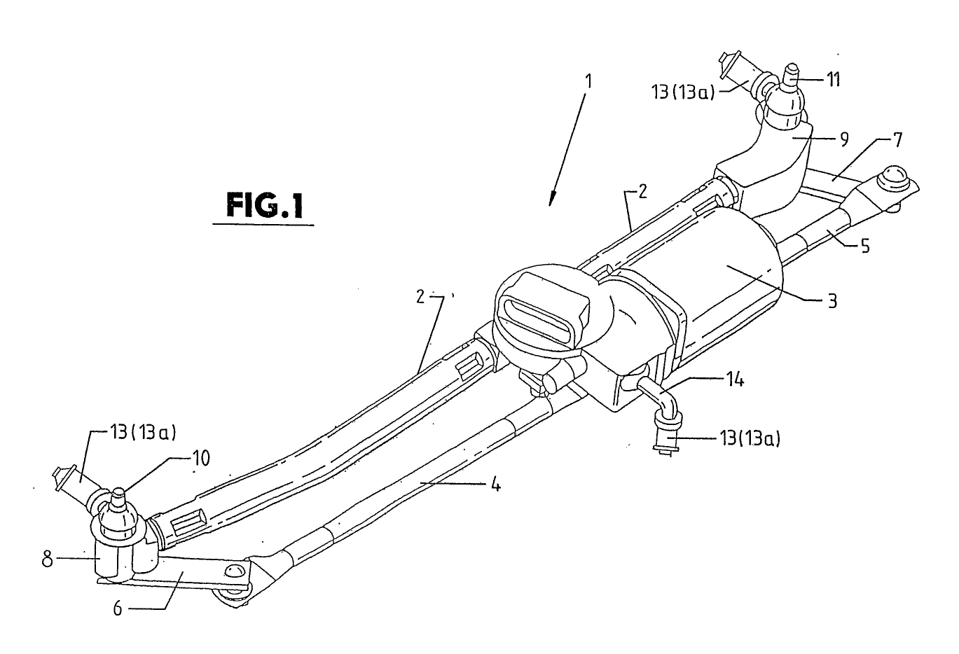

FIG. 1 perspective representation of a windscreen wiper system for vehicles with a carrier installable on vehicle bodywork by engagement;

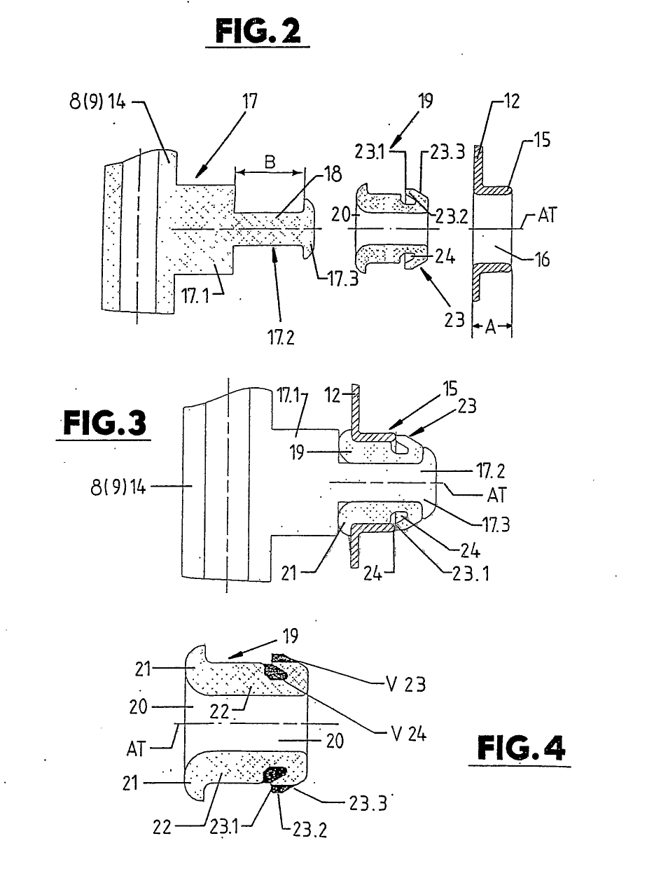

FIG. 2 the elements of a fixing element of the carrier, together with a an attachment or fixing hole formed by a passage in the vehicle bodywork, as a cross-section respectively;

FIG. 3 the fixing element in FIG. 2 with a carrier fixed to the bodywork;

FIG. 4 individual representation and cross-section of the grommet made of elastic rubber material of the fixing element in FIGS. 2 and 3;

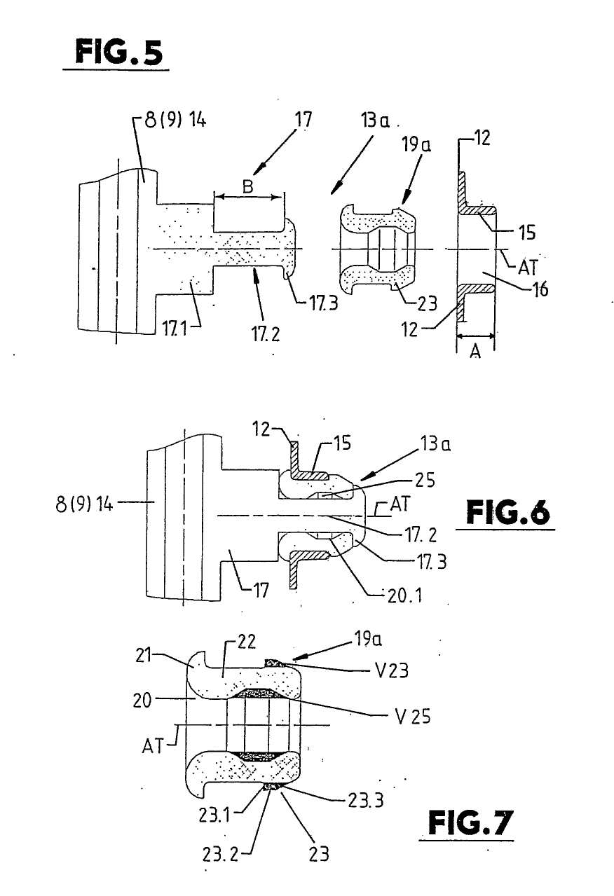

FIG. 5-7 representations similar to FIGS. 2-4, but with a further possible realisation of the invention.

In FIG. 1, a windscreen wiper system for motor vehicles, which in the well-known manner essentially consists of a tube-like carrier 2, an electromotive drive 3, fixed laterally to the carrier between both ends of the carrier and which has a winder on its output shaft, two coupling rods 4 and 5, which are respectively hinged at one end to the winder which is not visible in FIG. 1 and with their other ends with an articulated connection with motion links 6 and 7, in addition to the wiper shaft bearings arranged 8 and 9 arranged at both ends of the carrier, in which one wiper shaft 10 and 11 is rotatably bedded. The wiper shaft 10 bedded in the wiper bearing 8 is connected to the motion link 6 projecting radially from this shaft and the wiper shaft 11 bedded in the wiper shaft bearing 9 is connected to the motion link 7 radially projecting from this shaft.

In order to fix the windscreen wiper system and the carrier 2 to a sheet 12 of the bodywork, provision is made for three fixing elements 13 in the realisation represented, which are of identical design respectively and form a three-point attachment or connection, in which the fixing elements 13, corresponding to the vertexes of a triangle, are arranged spatially offset in relation to one another. In this sense, two fixing elements 13 are located at the ends of the tube-shaped carrier 12 and at the wiper shaft bearings 8 and 9 at this position. A fixing element 13 is arranged on an additional carrier arm 14 projecting from the electromotive drive 3.

In the realisation represented, both fixing elements 13 are arranged on the wiper shaft bearings 8 and 9 with their axes approximately parallel to each other and on a joint level. The fixing element 13 at the end of the angled carrier arm 14 is oriented with its axis crossways or vertical to this level.

All the fixing elements 13 are designed in such a way that by means of the latter, installation of the windscreen wiper system 1 and the carrier 2 to the vehicle bodywork is respectively possible by axial insertion of the peg-like fixing element 13 into a fixing opening formed in the realisation presented by a passage 15 and by engagement at this passage 15 and at the fixing opening 16.

FIGS. 2 and 3 show one of the fixing elements 13 in an enlarged presentation, together with the panel 12 and the passage 15 forming the fixing opening in this panel.

Each fixing element 13 essentially consists of a peg 17, which is integrally moulded on the wiper shaft bearing 8 or 9 or formed however by the end of the carrier arm 14. Starting from the wiper bearing 8 and 9 or the carrier arm 14, the peg 17 initially has a peg cutout 17.1 with an enlarged diameter and from there onwards a section 17.2 with a reduced diameter. In the peg section 17.2, a circumferential groove 18 is made, the width of which takes up almost the entire axial length of the peg section 17.2, so that the peg section 17.2 with the groove 18 has a mushroom-peg-shape with an enlarged peg end 17.3 in its cross-section. A component of each fixing element 13 is in turn a bush or grommet 19 made of permanently elastic material, for example of rubber or an elastomer plastic. The axial overall length of the grommet 19 is equal to or slightly greater than the width W of the groove 18. The diameter of the bush opening 20 of the grommet 19 is equal to or slightly less than the diameter which the peg section 17.2 has in the area of the groove 18. At one end, the grommet 19 is formed in one piece with a flange-like section 21 with an enlarged outside diameter, continued to the other grommet end by a section 22, at which the grommet 19 and the cylindrically shaped die outer surface of this grommet has a diameter which is smaller than that of the outside diameter of the section 22, but equal to or slightly greater than the cross-section of the opening 16. At the other end distant from section 21, the grommet 19 is shaped with a ring-like projection acting 23 as a catch, which encloses the axis AT of the grommet 19 concentrically and projects over the cylindrically shaped outer surface of section 22. On its side facing the section 21 the projection 23 forms a locking area 23.1 and afterwards a ring area 23.2 and on the side facing away from the section 21, a tapering cone area towards the neighbouring end of the grommet 19.

Directly at the locking area 23.1 a ring-shaped groove or cutout 24 concentrically enclosing the axis of the grommet 19 in addition to the grommet opening 20, which stretches with an extension also under the projection 23 and is open on the circumferential surface of the grommet 19 and the grommet section 22 in the immediate vicinity of the locking area 23.1. The circular groove-like cutout 24 is designed in such a way that with elastic deformation of the projection 23 radially towards the inside of this projection and the material of the grommet 19 displaced during this elastic deformation can be accommodated by the cutout 24.

As shown in the figure, the volume V24 of the cutout 24 is selected in such a way that it is at least equal to, but preferably slightly greater than the volume V23 of the ring-shaped projection 23 projecting over the cylindrical circumferential area of the grommet section 22.

With a ready-installed fixing element 13, the grommet 19 sits secured against axial displacement on the peg section 17.2 and indeed in such a way that the grommet 19 is appropriately accommodated in the groove 18, the grommet section 21 on the side of the groove 18 neighbouring the peg section 17.1 and the end of the grommet with the ring-like projection 23 on the side of the groove 18 neighbouring the peg end 17.3 support each other. The external diameter of the end of the peg 17.3 is smaller in this case than the external diameter of the grommet 19. For installation of the fixing element 13, the grommet 19 manufactured in an injection moulding procedure for example is pushed on to the section 17.2 or the grommet 19 is produced by a suitable method on the peg section 17.2 by spraying.

During installation of the windscreen wiper system 1, each peg 17 fitted with the grommet 19 is inserted in the opening 16 of the corresponding passage 15, with the projection 23 being initially pressed elastically radially inwards into the cutout 24 over truncated cone section 23.3 and being accommodated by this cutout and indeed for as long the peg 17 with the grommet 19 has not been pushed completely into the opening 16 and the projection 23 exists again, i.e. can move radially outwards and at the same time with its locking area 23.1 which grasps behind and engages on the opposite surface of the passage 15 surrounding the opening 16, so that subsequently the windscreen wiper system 1 is held on the bodywork by engagement by means of the fixing element 13 involved. A particular advantage of the fixing elements 13 lies in the fact that with limited installation force due to appropriate choice of the material for the grommet, secure anchoring in the respective fixing opening 16 is achieved, so that in spite of a reduced installation force, the windscreen wiper system and its carrier 2 is reliably held on the vehicle bodywork and in particular also the forces arising during operation of the windscreen wiper system do not result in disassembly of the system.

FIGS. 5-7 show as a further possible realisation a fixing element 13a, which only differs from the fixing element 13 by the fact that instead of the grommet 19, a grommet 19a is used. The latter possesses in turn the grommet sections 21 and 22 and the projection 23 arranged on the end of the grommet 19a with the locking area 23.1, the cylinder or ring area 23.2 and the conical area 23.3. In case of the grommet 19a however, the circular groove-like cutout 24 is missing. Instead of this cutout 24, the grommet opening 20 is designed with a cutout 20.1 with an enlarged diameter, to be more precise between both ends of the grommet 19a. The section 20.1 extends in the realisation presented approximately under the ring area 23.2, the locking area 23.1 and over a partial length of the part of the grommet section 22 formed between the locking area 23.1 and the grommet section 21. In case of the grommet 19a mounted on the peg section 17.2, which is in turn pressed up with its grommet section 21 against the side of the groove 18 neighbouring the peg section 17.1 and with its other end of the grommet against the edge of the groove 18 neighbouring the peg section 17.3, the section 20.1 forms a cavity 25. The volume V25 of this cavity is selected in such a way that it is at least equal to, but preferably greater than the volume V23 of the ring-like projection 23, so that on installation of the windscreen wiper system 1 having the fixing elements 13a, on inserting the respective fixing element 13a into the fixing opening 16 of the respective projection 23 radial deformation inwards is possible and indeed with accommodation of the grommet volume hereby displaced in the cutout 25 until after complete insertion of the fixing element 13a in the fixing opening 16 formed by a passage 15, the projection can return radially outwards into its initial position and as a result grip behind and engage on the edge surrounding the opening 16 of the passage. In this realisation too, owing to section 20.1 and the cavity 25, a high load bearing capacity anchoring is achieved with limited installation force.

In both realisations, the grommet 19 and 19a is respectively designed in such a way that the axial distance between the locking area 23.1 and the side of the grommet section 21 facing the this locking area is at the most equal to, but preferably somewhat smaller than the axial dimension A of the passage 15, so that particularly through elastic deformation of the grommet section 21 installation of the windscreen wiper system 2 free of play is achieved on the bodywork.

The invention has been described above based on examples of execution. It is understood that modifications and alterations are possible without as a result abandoning the thoughts on which the invention is based. It is therefore possible for example to arrange the fixing elements 13 or 13a or similar fixing elements on the body of the car or on the vehicle bodywork or on holding devices at this site and the corresponding attachment or fixing holes on the windscreen wiper system or on the carrier. Combinations are also possible, e.g. realisations in which a part of the fixing elements are arranged on the windscreen wiper system and a part of the fixing elements on the vehicle bodywork or on carriers at this site.

### LIST OF REFERENCE MARKS

1 Windscreen wiper system
2 Carrier
3 Electromotive drive
4, 5 Coupling rod
6, 7 Motion link
8, 9 Wiper shaft bearing
10, 11 Wiper shaft
12 Car body or bodywork panel
13, 13a fixing element
14 Carrying arm
15 Passage
16 Attachment or fixing hole
17 Peg
17.1, 17.2 Peg section
17.3 Free peg end
18 Groove
19, 19a Grommet in elastic material
20 Grommet opening
20.1 Section of the grommet opening enlarged in cross-section
21, 22 Grommet section
23 Projection
23.1 Locking area
23.2 Ring area of the projection
23.3 Conical area of the projection
24 Ring-groove-like cutout with extension in the grommet
25 Cavity formed by the opening section 20.1
A Axial dimension of the passage 15
B Width of the groove 18
AT Grommet axis
V23, V24, V25 Volume

1. Windscreen wiper system for vehicles, particularly for motor vehicles with at least three connections at intervals from one another for screw-free installation of a windscreen wiper system or a carrier of this system on a vehicle bodywork, with the fixings consisting respectively of a fixing element which can be pushed into an attachment or fixing hole where it can be anchored by engagement and with at least one fixing element having a grommet in elastic material which can be inserted into the attachment or fixing hole, designed with at least one projection acting as a catch, characterised by the fact, that on the grommet in the area of the projection, at least one cavity is arranged radially inwards opposite the projection with reference to a grommet axis.

2. Windscreen wiper system according to claim 1, characterised by the fact that the cavity is a cutout, for example a circular groove-like cutout.

3. Windscreen wiper system according to claim 2, characterised by the fact that the cavity is a cutout open towards the circumference of the grommet.

4. Windscreen wiper system according to claim 1, characterised by the fact that the cavity has an extension stretching under the at least one projection.

5. Windscreen wiper system according to claim 1, characterised by the fact that the cavity on the circumferential area of the grommet is open near the locking area.

6. Windscreen wiper system according to claim 1, characterised by the fact that the at least one projection is a circular-shaped projection concentrically enclosing the grommet axis.

7. Windscreen wiper system according to claim 1, characterised by the fact that the cavity is formed by a section of the grommet opening with an enlarged cross-section.

8. Windscreen wiper system according to claim 1, characterised by the fact that the grommet is manufactured from an elastic rubber material, for example from rubber or an elastic rubber plastic.

9. Windscreen wiper system according to claim 1, characterised by the fact that the grommet forms a further contact surface axially distanced from the at least one locking area and that the axial distance between these further contact surfaces on the grommet side and the at least one locking area are at the most equal to or less than the axial distance between a first surface gripped from behind at the attachment or fixing hole formed by the locking area and a second surface formed at the attachment or fixing hole which lies against the further contact surface on the grommet side.

10. Windscreen wiper system according to claim 9, characterised by the fact that the further contact surface on the grommet side is formed by a flange-like grommet section projecting over the circumference of the grommet.

11. Windscreen wiper system according to claim 1, characterised by the fact that the grommet is arranged without possibility of axial displacement on a peg or section of peg of the fixing element.

12. Windscreen wiper system according to claim 11, characterised by the fact that the grommet is safeguarded by back cuts between the peg and grommet axially on the peg.

13. Windscreen wiper system according to claim 12, characterised by the fact that the peg or the peg section has at least one groove to accept the grommet.

14. Windscreen wiper system according to claim 1, characterised by the fact that the fixing elements are at least arranged in part on the windscreen wiper system or on an element of the windscreen wiper system and the corresponding fixing or attachment openings are arranged on the bodywork side.

15. Windscreen wiper system according to claim 1, characterised by the fact that the fixing elements are at least arranged in part on the bodywork side and the corresponding fixing or attachment openings on the windscreen wiper system or on a functional element of the windscreen wiper system.

16. Windscreen wiper system according to claim 1, characterised by the fact that the volume of the at least one cavity is at least equal to the volume of the projection.

17. Fixing element for screw-free installation of a windscreen wiper system for vehicles, particularly for motor vehicles on vehicle bodywork, in which the fixing element which can be pushed into an attachment or fixing hole and be anchored there by engagement, has a grommet made of an elastic material, which can be inserted into the attachment or fixing hole and is designed for engagement with at least one projection acting as a catch, characterised by the fact, that on the grommet in the area of the projection, at least one cavity is arranged radially inwards opposite the projection with reference to a grommet axis.

18. Fixing element according to claim 17, characterised by the fact that the cavity is a cutout, for example a circular groove-like cutout.

19. Fixing element according to claim 18, characterised by the fact that the cavity is a cutout open towards the circumference of the grommet.

20. Fixing element according to claim 17, characterised by the fact that the cavity has an extension stretching under the at least one projection.

21. Fixing element according to claim 17, characterised by the fact that the cavity on the circumferential area of the grommet is open near the locking area.

22. Fixing element according to claim 17, characterised by the fact that the at least one projection is a circular-shaped projection concentrically enclosing the grommet axis.

23. Fixing element according to claim 17, characterised by the fact that the cavity is formed by a section of the grommet opening with an enlarged cross-section.

24. Fixing element according to claim 17, characterised by the fact that the grommet is manufactured from an elastic rubber material, for example from rubber or an elastic rubber plastic.

25. Fixing element according to claim 17, characterised by the fact that the grommet forms a further contact surface axially distanced from the at least one locking area and that the axial distance between these further contact surfaces on the grommet side and the at least one locking area are at the most equal to or less than the axial distance between a first surface gripped from behind at the attachment or fixing hole formed by the locking area and a second surface formed at the attachment or fixing hole which lies against the further contact surface on the grommet side.

26. Fixing element according to claim 25, characterised by the fact that the further contact surface on the grommet side is formed by a flange-like grommet section projecting over the circumference of the grommet.

27. Fixing element according to claim 17, characterised by the fact that the grommet is arranged without possibility of axial displacement on a peg or section of peg of the fixing element.

28. Fixing element according to claim 27, characterised by the fact that the grommet is safeguarded by back cuts between the peg and grommet axially on the peg.

29. Fixing element according to claim 28, characterised by the fact that the peg or the peg section has at least one groove to accept the grommet.

30. Fixing element according to claim 17, characterised by the fact that the volume of the at least one cavity is at least equal to the volume of the projection.
